(19) United States
(12) Patent Application Publication
(10) Pub. No.: US 2005/0106072 A1
(43) Pub. Date: May 19, 2005

(54) Device and cover providing access to samples in a sample plate

(75) Inventor: Philippe Benech, Marseille (FR)

Correspondence Address: YOUNG & THOMPSON, 745 SOUTH 23RD STREET, 2ND FLOOR, ARLINGTON, VA, 22202, US

(73) Assignee: Centre National De La Recherche Scentifique-CNRS, Paris Cedex 16 (FR)

(21) Appl. No.: 10/508,679

(22) PCT Filed: Mar. 26, 2003
(86) PCT No.: PCT/FR03/00958

(30) Foreign Application Priority Data
Mar. 26, 2002 (FR) 02/3786

(51) Int. Cl. B01L 3/00

(52) U.S. Cl. 422/102; 422/99

(57) ABSTRACT

A device formed of a sampling “plate” includes an assembly of elements for individual storage samples regularly arranged in a line x column matrix, each of the storage elements may be accessed for placing or taking a sample, a lid may be installed on the plate in order to isolate the storage elements from the environment. The lid includes movable access elements enabling, in a first opening position, to access at least one of the storage elements and, in a second closing position, to isolate the at least one of the storage elements from the environment in order to enable, in the first opening position, access to the one storage elements the lid being arranged on the plate and including one fixed part and at least one mobile part. The mobile part is a disk mobile in rotation or a plate in translation.

The present invention relates to a sampling plate device with a lid enabling access to the samples. It finds application in the field of sample handling and, in particular, automated placing and taking biological products. A lid for a sampling plate is also included in the invention.

Modern sample analysis means make use of <<plates >> which are trays, generally made of thermoplastic or thermosettable synthetic material, comprising an assembly of means for individual storages of samples. These storage means are of cup, well or tube type wherein the samples are arranged individually. The terms cups, well and tubes are considered as functionally equivalent within the framework of the invention and are also grouped under the designation ‘storage means’. These storage means are generally arranged on the <<plate>> according to a regular distribution, in a line x column matrix.

Conventionally, <<plates>> including 96 storage means are available and it is possible to access each storage means individually as well to insert a sample therein, take a sample or perform any operation necessary within the framework of an analysis. Access to a sample is provided without any contamination of the other samples. The term sample refers to any product or composition which may be inserted in the storage means, for example a product to be analysed or a reactive product. For example, the samples may correspond to an increasing dilution of the same product and the analysis may consist in inserting different reactants according to the storage means considered or the same reactant in several storage means, as well within the framework of a qualitative analysis as a quantitative analysis.

Outside the time periods where it is necessary to access the storage means, it is generally necessary to close hermetically each of the storage means to avoid contamination of or to the environment, possibly among the storage means or evaporation of the samples. It may be for example necessary to stir the <<plate>> in order to mix several products forming the sample and it goes without saying that preferably the storage means should then be closed.

At the moment, the closing of the <<plates>> is provided by a removable lid which is withdrawn or replaced by the user each time he needs to access one or several of the samples. For usages such as PCR, different types of lids and of <<plates>> are thus offered on the market: continuous lid exhibiting under the lower portion studs for insertion into the well or <<plates>> integrating strips of eight tubes whereon is superimposed an eight-plug strip. More recently, to comply with the automation need, companies have developed machines for ensuring the closing of the <<plates>>: an automaton screwing plugs one by one or automata capable of sealing on a <<plate>> a plastic film fed by an unwinder roll. Once the lid in place, the samples are therefore not accessible any longer and the lid must be removed in order to access thereto.

These diverse techniques may exhibit shortcomings and, for example, the lid may possibly strongly resist the opening and there is then a risk of toppling the samples in case of sudden release. Moreover, access to the samples is made in an all or nothing pattern, i.e. an assembly of storage means which becomes accessible once the lid has been removed whereas only a small number of samples may be required in this set. One thus incurs the risk of contaminating samples to which there is no need to access.

It may therefore be particularly useful to have an individual or per sub-assembly or global access means, of storage means of a sampling <<plate>> which does not involve removing a lid.

It is thus that since the documents GB-2 356 253 or EP-10 25 902 or WO 01/51099, sliding aperture devices have been known, enabling to mask or to expose reservoirs.

Below, the term <<plate >> will be used in quotes to designate the element including the storage means and to differentiate it from the word plate in its meaning as a thin elongated element and which corresponds to the general shape of the <<plate>> and of certain means of the invention as will now be seen.

There is therefore provided a device formed of a sampling “plate” comprising an assembly of means for individual storage samples regularly arranged in a line x column matrix, whereas each of the storage means may be accessed for placing or taking a sample, a lid may be installed on the <<plate >> in order to isolate the storage means from the environment.

According to the invention, the lid comprises movable access means enabling, in a first opening position, to access at least one of the storage means and, in a second closing position, to isolate said at least one of the storage means from the environment in order to enable, in the first opening position, access to said at least one storage means whereas the lid is arranged on the <<plate>>.

In diverse embodiments of the invention, the following means liable to be combined according to all the technically available possibilities are employed:
the storage means are regularly arranged in a line x column matrix,
the gauge of the matrix is square, rectangular, triangular, polygonal, oval or circular, (signifies that the outermost storage means of the <<plate>> are on this type of curve)
the device comprises a number N of storage means, N being greater than or equal to 16,
the lid comprises one fixed part and at least one mobile part, the parts being superimposed,
the lid comprises one fixed part and at least one mobile part, said parts being superimposed, and the fixed part is a plate arranged against the <<plate>> spanning storage means, the plate comprising at least one access port per storage means, and the mobile parts each include at least one aperture,
the mobile parts include at least one aperture per corresponding access port,
the lid comprises one fixed part and at least one mobile part, said parts being superimposed, and the mobile parts are arranged against the <<plate >> spanning at least one storage means and the fixed part comprising at least one access port per storage means spans the assembly composed of <<plate>> and mobile part, and the mobile part(s) comprise at least one aperture,
the mobile part(s) comprise at least one aperture per corresponding access port,
the mobile part may be moved relative to the fixed part for at least one storage means, so that in the first opening position, the aperture coincides with the corresponding port and that, in the second closing position, the aperture does not coincide with a corresponding port,
a slit cover is moreover arranged over the assembly composed of the fixed and mobile part(s),
a slit cover is moreover arranged over the mobile part(s),
the displacement corresponds to a translation,
the displacement corresponds to a rotation,
the storage means are cups,
the storage means are wells,
the storage means are tubes,
the fixed part includes one port of predetermined shape per storage means and the mobile part includes one aperture of the same predetermined shape, whereas the edges of the port and of the aperture coinciding substantially in the first opening position,
the lid is removable on the <<plate >>,
the lid is interconnected with the <<plate >>,
in the case of a lid including several mobile parts, at least two mobile parts include therebetween at least one reciprocal driving means,
the driving means between two or more mobile parts is disengageable,
the fixed part and the mobile part are superimposed plates which may translate relative to one another,
the translation comprises at least one sliding means (guillotine),
at least one mobile part of the lid controls access to at least one line or column of corresponding storage means,
one mobile part in translation controls access to at least one line or column of storage means,
the lid comprises one mobile part in translation for all the storage means,
as a driving means, at least two mobile parts in translation are anchored to a detachable rigid linking part, said linking part enabling the transmission of the translation between the mobile parts anchored to one another,
the linking part is a rod covering mobile parts, and may slide on the mobile parts which are not anchored to one another, (the linking part runs as a rolling bridge on the non-anchored mobile parts),
the mobile part is a disk mobile in rotation with respect to the fixed part, the fixed part being a plate and the disk having a circular periphery,
the lid comprises one disk per storage means,
the lid comprises at least one disk common to a sub-assembly of storage means adjacent to one another,
the sub-assembly comprises a number S² of adjacent storage means forming a square matrix with S>1 and, more preferably with S=2 for a sub-assembly of four storage means,
the lid comprises at least one disk common to a sub-assembly of storage means adjacent to one another, the sub-assembly comprises a number S² of adjacent storage means forming a square matrix with S>1 and, preferably with S an even number, and more preferably with S=2 to control access to a sub-assembly of four storage means,
as a driving means, the disks comprise at their peripheries teeth on at least one sector, said teeth of two adjacent disks engaging into one another to form the reciprocal driving means.

The invention also relates to a lid according to the one or several of the essentially combined, corresponding preceding characteristics.

This device exhibits several advantages:
(i) It is cheap and does not require any costly equipment.

(ii) It does not require any significant effort on the user's part for the operation thereof. Access to the storage means may be provided in a single operation, by simple sliding of approximately 5 mm or by a rotation according as the case may be, the assembly of the well (or a or several sub-assemblies) being then open or closed according to the position.
(iii) Contrary to the existing systems, the device of the invention prevents any contamination of the samples in a given well by those of the adjacent wells.
(iv) It is adaptable to automation.
(v) Its integrity is preserved during the manipulations, which is not the case of the systems using plug strips or a film.
(vi) It may be made of sterilisable materials and consequently may be re-usable. It may also be of throw-away type, thanks to a cheap realisation.
(vii) According to the materials, it may resist a wide temperature range (required for PCR) and storage at −20° C. or 80° C.

The invention will now be exemplified by the detailed description of two embodiments and in connection with:

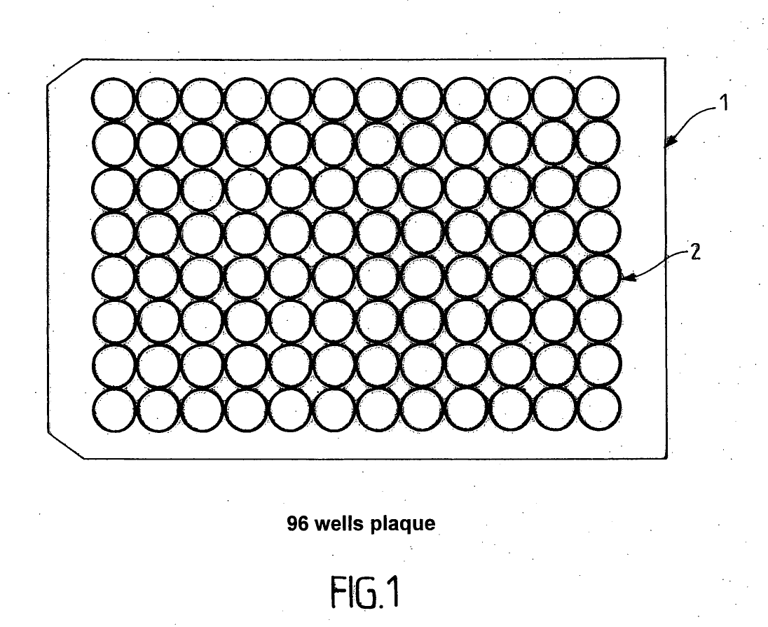

FIG. 1 representing a 96-well plate,

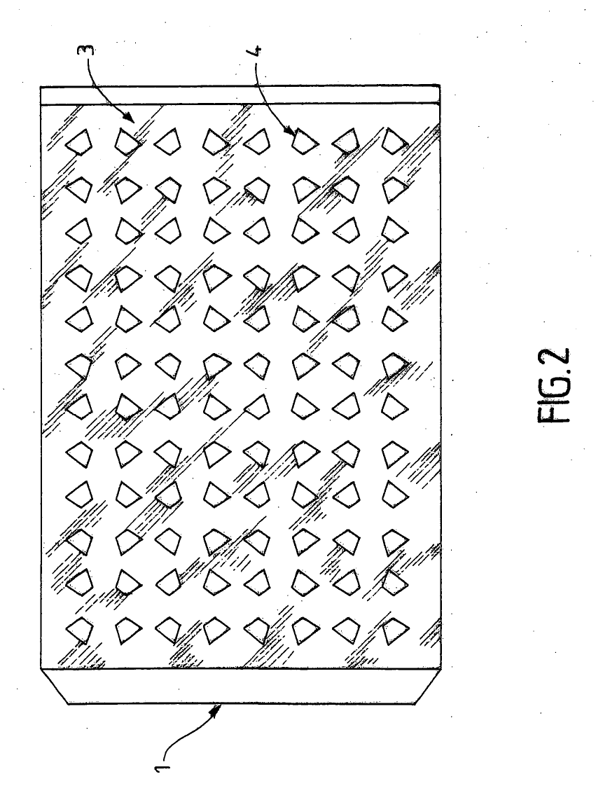

FIG. 2 representing a fixed part of a first type of lid,

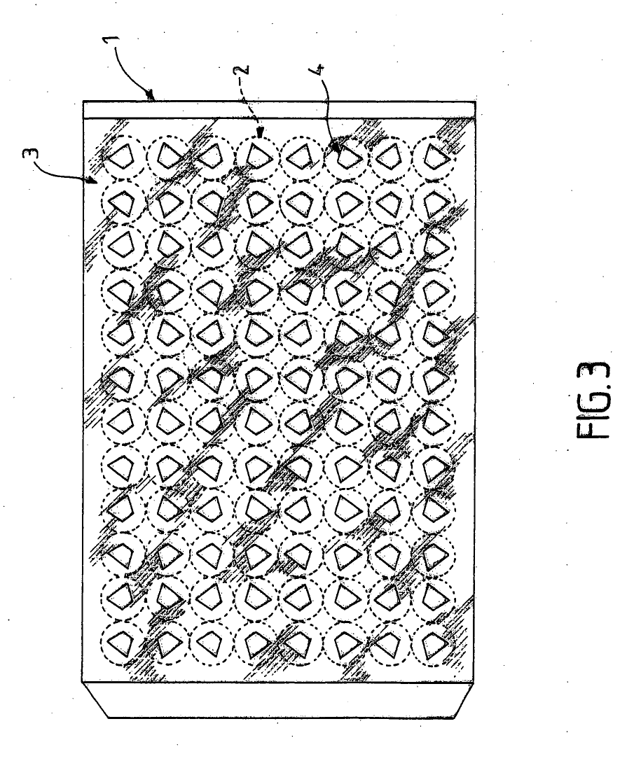

FIG. 3 representing a superimposition <<plate>> and fixed part,

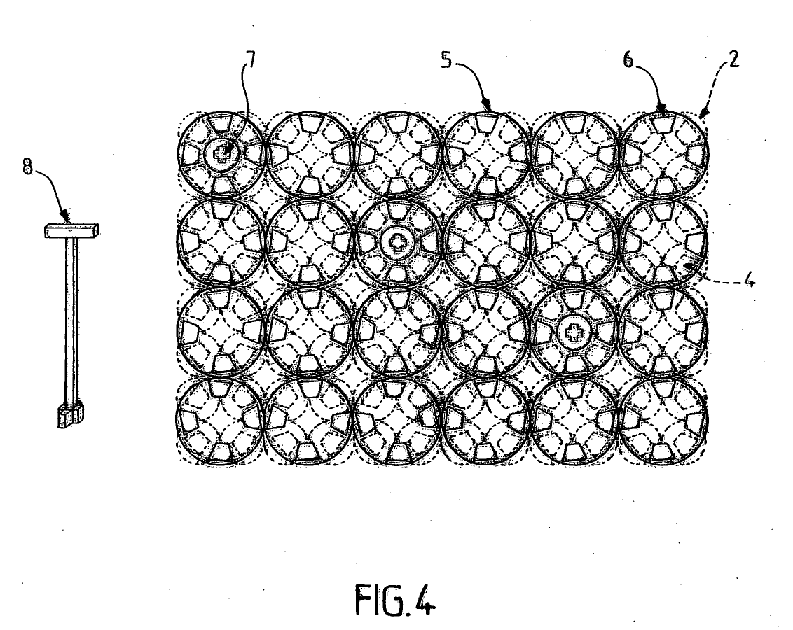

FIG. 4 representing mobile parts in rotation against one fixed part,

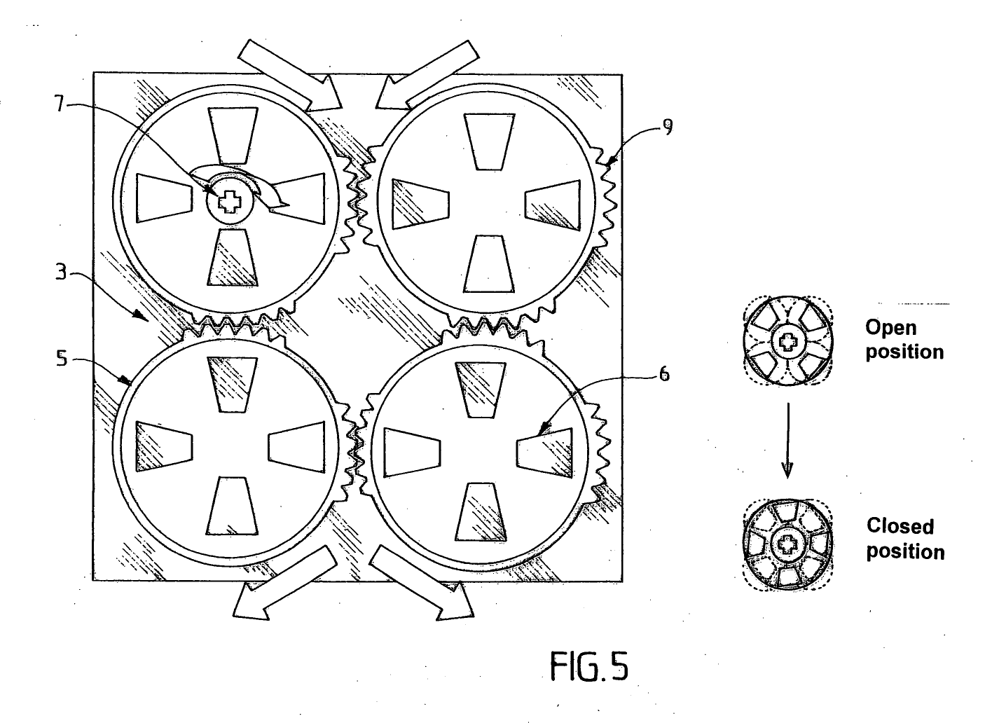

FIG. 5 representing a detailed view of a rotational driving system of mobile parts,

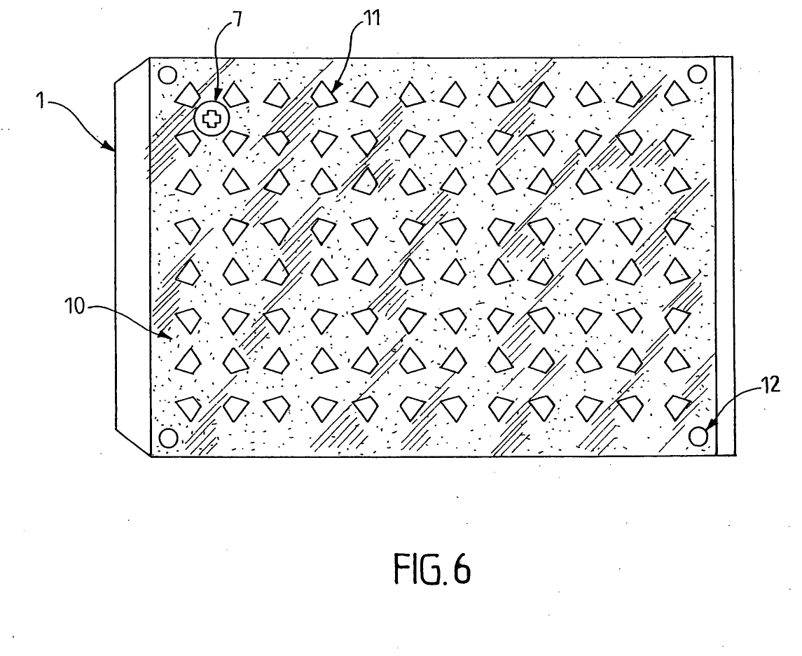

FIG. 6 representing a second slit, fixed part, so-called cover of the lid,

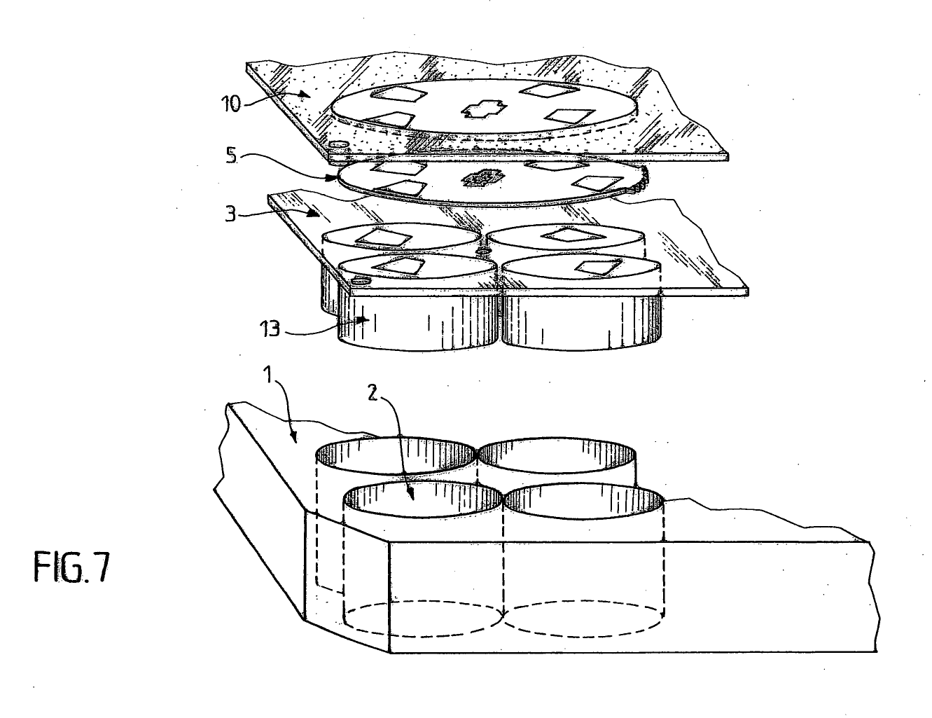

FIG. 7 representing an exploded perspective view of the <<plate>>, of the fixed and rotational mobile parts and of the cover,

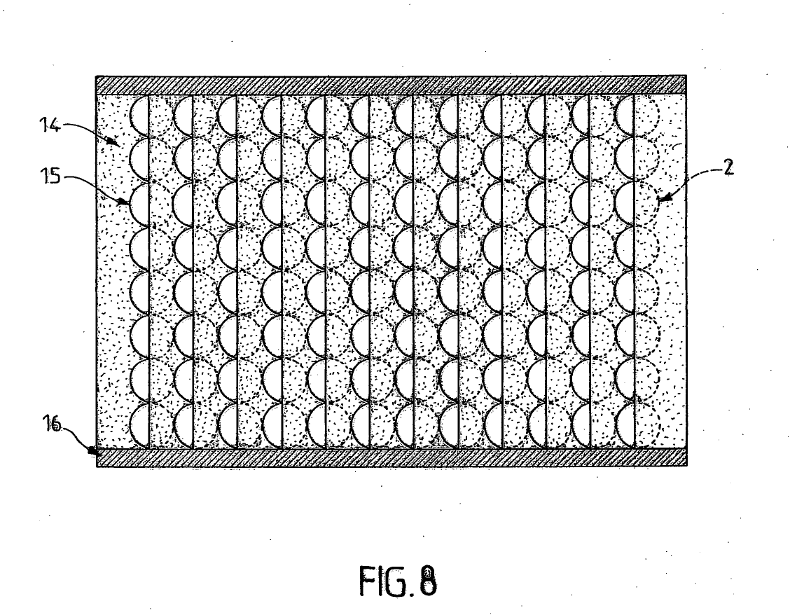

FIG. 8 representing a part of a second type of lid,

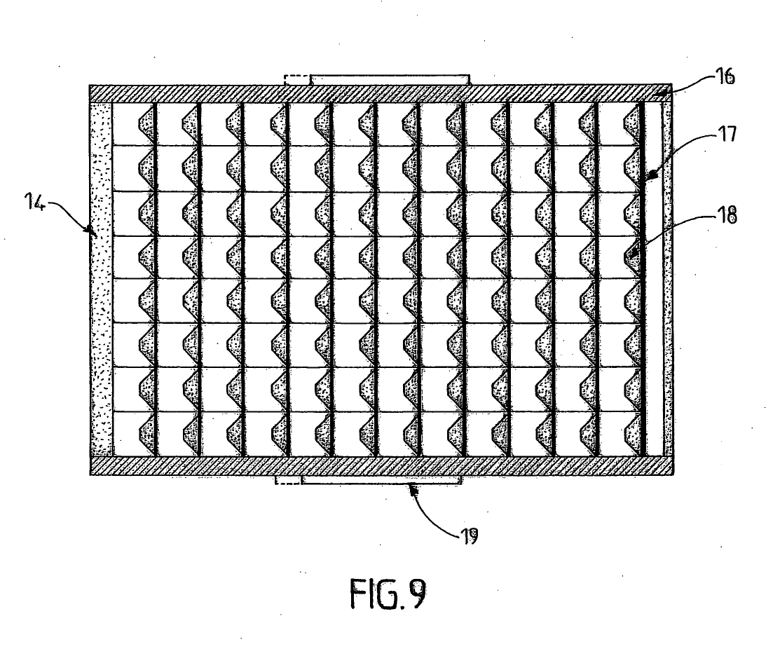

FIG. 9 representing one mobile part of the second type of lid in open position,

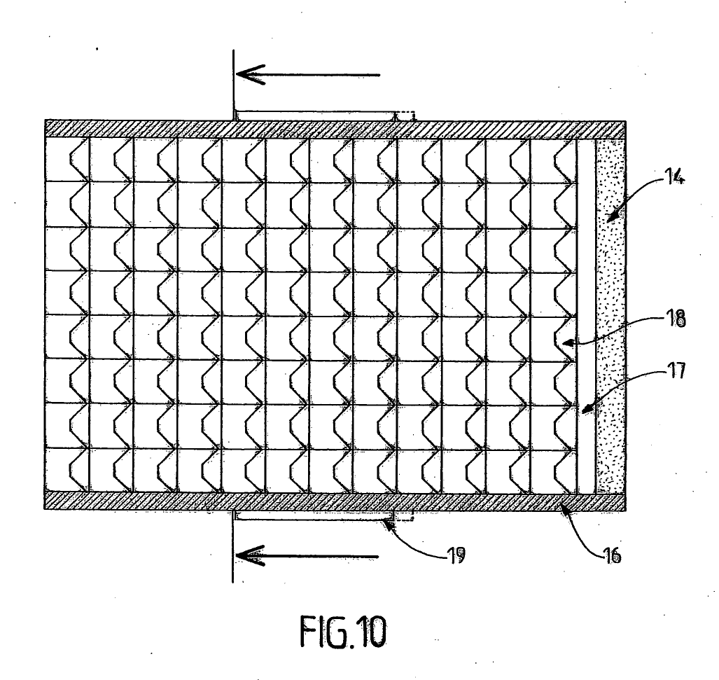

FIG. 10 representing one mobile part of the second type of lid in closed position after sliding,

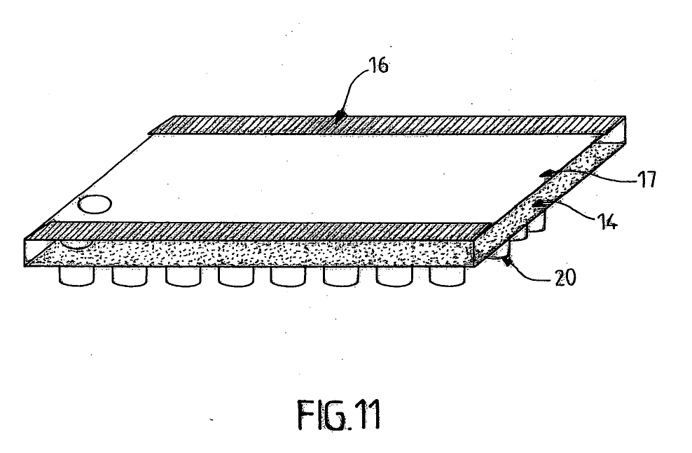

FIG. 11 representing a perspective view of a fixed part intended for insertion into a <<plate>>.

The device is formed of a <<plate>> with storage means of the cup, well or tube type, covered with a lid which may be detachable or not, i.e. it may be removed if necessary or it is fixed permanently. The lid is composed of two (or more) superimposed parts in the form of plates which will be positioned on the <<plate>>. The first part is fixed and is drilled at regular intervals with access ports in relation with the storage means of the <<plate>>. Preferably, the fixed part integrates in its lower section, studs engaging into the wells or the tubes of a well or tube type <<plate>> for ensured tightness of the assembly covering the fixed part on the <<plate>>. The second part(s) are, conversely, mobile in translation (guillotine) or rotation with respect to the fixed part in order to expose or not the storage means by coinciding or not the ports of fixed part and apertures of mobile part(s). The displacement of the fixed and mobile parts relative to one another corresponds therefore to a translation (or slide) which may be either linear or rotational.

The structure of the second part(s) depends on the embodiment of the invention and two options are possible and for example in function of a manual or robotised usage.

In a first option, the second part is mobile in rotation on the fixed part. In the case of a <<plate >> fitted with 96 wells or tubes, 24 notched disks are arranged on the fixed part, each covering the surface of four wells or tubes. The second part in the form of a disk is drilled by apertures so that during rotation, the apertures will be superimposed with respect to the ports of the first plate. In the case of notched disks for common driving of the assembly or of a sub-assembly of the disks, one or several disks integrate in their centres a nest wherein is inserted a rod whereof the end matches the nest for rotational driving. Preferably, all the disks are identical and include said nest, the driving of the disks may then be controlled from any disk. Thus, a simple rotation of that rod will induce a movement of the disk whereof the notches will ensure the rotation of the others, like a snowball effect. A cover may span the mobile parts, the latter being then sandwiched between the fixed part and the cover. In an alternative, the mobile parts are against the <<plate>>.

In a second option, the second part with apertures is mobile in translation on the first part for masking or exposing corresponding ports and hence provides access or not to the storage means. Several mobile parts in translation may be arranged on the fixed part, each for one or several lines and/or columns.

A slit cover may therefore be arranged over the mobile part(s) to hold them in place, whereas they are free in rotation. It is obvious that the cover is slit to provide access to the storage means when the mobile part is in opening position. Alternately, the mobile part(s) is (are) arranged against the <<plate >> and the fixed part covers the assembly composed of the mobile part(s) and <<plate>>, the fixed part then playing also the part of the cover of the previous embodiment while limiting the number of elements necessary.

In the first as well as in the second option, the number of storage means corresponding to a given mobile part may be included between one (one mobile part per storage means) and the number total of storage means (one single part in translation on the fixed part or a single disk in the case of a circular gauge matrix of storage means on the <<plate >>).

On FIG. 1, a <<plate >>1 fitted with 96 wells 2 is seen from above. The wells are arranged according to a regular rectangular line/column matrix. The plate is made in a sheet of rigid material and, preferably, in a hot-moulding synthetic material. Alternately, the plate is a thick sheet of rigid material and the wells are provided in said thickness. Within the framework of the invention, the tubes may be detachable or not and, in the latter case, the lid exhibits the additional advantage of being able to lock in place, on the <<plate>>, the detachable tubes.

On FIG. 2, the fixed part 3 of a first type of lid (first option) is seen from above. This part is realised in a sheet of rigid material and, preferably, in a hot-moulding synthetic material. The fixed part is intended for application over >>the plate>> as represented on FIG. 3 and it comprises access ports 4 enabling to access to the wells. This fixed part is generally flat in shape.

FIG. 3 enables to visualise the assembly composed of the <<plate>> 1 and the fixed part 3. The wells 2 are visible by transparency as dotted lines and it may be noticed that the access ports 4 are arranged to coincide With the wells.

FIG. 4 represents several mobile parts which in this first type of lid are circular disks 5, mobile in rotation around an axis running through the centre of the disk. Each of the disks comprises four apertures 6. Each disk 5 is hence in relation with a sub-assembly of four storage means 2 in square matrix relation of the <<plate>>. The rotational axis of the disk runs substantially through the centre of the matrix so that a rotation of the disk causes either the masking of the access ports 4 or the exposure of said ports. On FIG. 4 the access ports of the fixed part are masked by the disks and said ports 4 and the storage means 2 have been represented in transparency. As explained below, the disks are driven together into rotation thanks to the rotation of the key-operated control member 7 whereof the key 8 is represented on the left on FIG. 4. In order to hold the disks axially, corresponding pins and bearings are provided between the fixed part and the disk. Other means (mobile part sandwiched between <<plate>> and fixed part or between cover and fixed part) explained below are also usable in combination or not with the pins and the bearings.

The control member 7 is included in one or several disks at the centre thereof. It is possible according to the distribution of the notches situated at the periphery of the disks to open or close, by simple rotation, a sub-assembly or the assembly of the storage means. The different distributions of the notches will correspond to distinct versions of the product (such as for example on FIG. 5). The key 8 is more particularly intended for manual control. It is contemplated to use a key-operated member on a machine for automated opening and closing of the access to the storage means.

FIG. 5 details the collective driving notch mechanism of the disks 5 thanks to teeth 9 engaging into one another between adjacent disks. The teeth 9 may be spread over the whole circumference of the disk 5 or, preferably on four sections only (or fewer) in order to limit the possibility of rotation between both closing and opening positions. An active rotation-limiting means may also be implemented by one or several locking teeth or an abutting toe. It is also possible to define sub-groups of disks in common rotation in order to grant access only to the storage means of the corresponding sub-group by providing disks with fewer than four toothed sections. Detachable driving means (clutch) between two or more sub-groups are usable.

This first option wherein the mobile parts are disks, is not intended for limiting the invention and other sizes of disks, other shapes and numbers of ports and apertures are contemplated than those represented, de-coupling (re-coupling—engaging) of the collective driving in several independent sub-group may also be implemented. The disk may be of different size according to the embodiment between one disk per storage means or one disk for all. In practice, one uses a disk for S² storage means grouped in a sub-assembly according to a square matrix with S>1, i.e. 4, 9, 16 or more storage means. It is however preferable that the number of storage means of the sub-assembly accessed by a disk is an even number so that the rotational axis does not coincide with one of the storage means. However, the greater the number of storage means per disk, the more complex the shape and arrangement of the ports and one prefers the disk for one or, as represented, for four storage means.

Finally, in particular in case when several well correspond to the same disk, more than two positions may be obtained, for example intermediate positions where only some of the wells are accessible in the sub-assembly.

FIG. 6 is a top view of a fixed cover 10 which is slit by apertures 11 which are superimposed on the apertures of the fixed part. At least one circular drilling of the fixed part 10 enables access to the control member 7 of one of the disks. The fixed part 10 is interconnected to the fixed part 3 by sealing screws or tabs 12.

In this configuration, the disks are sandwiched between the fixed part in contact with the <<plate>> and the cover as represented on FIG. 7.

FIG. 7 is an exploded perspective view of the fixed 3 and mobile 5 parts and of the cover 10. The fixed part 3 includes in its lower section 96 empty honeycombs 13 which enable the nesting thereof on the <<plate>>1 fitted with 96 wells 2. The cover 10 is preferably emptied in its inner section at the contact with the disks to enable the rotation thereof in the thickness of the cover thereby holding them axially. The disks are therefore housed in the thickness of the cover.

FIG. 8 is a top view of one fixed part 14 for a second type of lid (second option). The fixed part 14 comprises half-moon access ports 15 which coincide with the storage means 2 visible in transparency on the one hand and directly on the other hand by the access ports 15. As previously, the fixed part 14 is arranged on the <<plate>>, covering said plate. The fixed part 14 exhibits girders 16 on its length, enabling the sliding of one mobile part 17 (FIG. 9). Alternately, the mobile part(s) is (are) arranged on <<the plate>> as explained at a later stage.

FIG. 9 enables to visualise apertures 18 regularly arranged on one mobile part 17 in translation. The mobile part 17 may be moved in translation on the fixed part thanks to the girders 16 enabling the sliding of the mobile part 17 whereof the translation is guided by toes 19. On FIG. 9, the ports and the apertures do not coincide and the storage means are not accessible.

FIG. 10, the mobile part 17 of the lid corresponding to FIG. 9 has been moved by sliding on the fixed part 14 and the ports are coincided with the apertures 18, rendering accessible the storage means of the <<plate>>.

FIG. 11 provides a perspective view of the second type of lid wherein the fixed part 14 comprises cylindrical extensions 20 (or honeycombs of the same type as those 13 of FIG. 7) intended for insertion in the well to ensure tightness between the plate and the fixed part 14. As represented on FIGS. 7 and 11, the lid in both options includes in its lower section 96 emptied honeycombs which enable the insertion thereof on the plate fitted with 96 wells, rendering the assembly perfectly hermetic. It is obvious that in such a case, the mobile part(s), in case where each of them gives access to several storage means, may not be arranged directly on the <<plate >>.

The invention is not limited by the previous description of the device fitted with sliding mobile parts or the rotational device and other shapes and numbers of ports and/or apertures are contemplated for the lid. Besides, the sliding mobile part may have a more limited surface area to correspond to a particular sub-assembly of storage means, for example, one, two or more lines or columns. In case when several sliding mobile parts are implemented, a collective driving, disengageable or not, may be applied.

1-10. (canceled)

11. A device formed of a sampling <<plate >> (1) comprising an assembly of means (2) for individual storage of samples, whereas each of the storage means may be accessed for placing or taking a sample, whereas a lid may be installed on the <<plate >> in order to isolate the storage means from the environment, the lid including rotational movable access means (3, 4, 5, 6, 10) enabling, in a first opening position, to access at least one of the storage means and in a second closing position to isolate said at least one of the storage means from the environment in order to enable, in the first opening position, access to said at least one storage means whereas the lid is arranged on the <<plate >>, characterised in that the storage means are regularly arranged in a line x column matrix and that the lid comprises one fixed part (3, 10) and at least one mobile part (5), said parts being superimposed, and in that the fixed part is a plate comprising at least one access port (4) per storage means, and in that the mobile parts are circular periphery disks, mobile in rotation and comprising at least one aperture (6) per corresponding access port, whereas the disk may be moved relative to the fixed part for at least one storage means, so that, in the first opening position, the aperture coincides with the corresponding port and that, in the second closing position, the aperture does not coincide with the corresponding port.

12. A device according to claim 11, characterised in that the plate is arranged against the <<plate >> spanning storage means.

13. A device according to claim 11 characterised in that the disks are arranged against the <<plate >> spanning at least one storage means.

14. A device according to claim 1, 2 or 3, characterised in that it includes moreover a slit cover (10) spanning the assembly composed of the fixed and mobile part(s).

15. A device according to claim 11, characterised in that in the case of a lid including several disks, the disks include therebetween at least one reciprocal driving means (7, 9).

16. A device according to the claim 15 characterised in that, as a driving means, the disks comprise at their peripheries teeth (9) on at least one sector, said teeth of two adjacent disks engaging into one another to form the reciprocal driving means.

17. A device according to the claim 15, characterised in that at least one of the disks comprises a central nest-type control member (7) intended for receiving a rotational driving key (8).

18. A device according to the claim 15, characterised in that at least one disk comprises an active rotation-limiting means with a locking tooth or an abutting toe.

19. A device according to claim 11 characterised in that the lid comprises at least one disk common to a sub-assembly of storage means adjacent to one another, the sub-assembly comprises a number S² of adjacent storage means forming a square matrix with S>1 and, preferably with S an even number, and more preferably with S=2 to control access to a sub-assembly of four storage means.

20. A lid for sampling “plate”, the sampling “plate” comprising an assembly of means for individual storage of samples, whereas each of the storage means may be accessed for placing or taking a sample, whereas the lid may be installed on the <<plate >> in order to isolate the storage means from the environment, the lid including rotational movable access means (3, 4, 5, 6, 10), enabling, in a first opening position, to access at least one of the storage means and, in a second closing position, to isolate said at least one of the storage means from the environment in order to enable, in the first opening position, access to said at least one storage means whereas the lid is arranged on the <<plate>>, characterised in that the storage means are regularly arranged in a line x column matrix and that the detachable access means of the lid comprise at least one disk mobile in rotation, the combination of the lid and of the <<plate >> forming a device according to any of the preceding claims.
